(19) United States
(12) Patent Application Publication
(10) Pub. No.: US 2022/0316906 A1
(43) Pub. Date: Oct. 6, 2022

(54) Apparatus and Method for Generating Navigational Plans

(71) Applicant: Naver Corporation, Gyeonggi-do (KR)

(72) Inventors: Yves HOPPENOT, Notre Dame de Mesage (FR); Michel LANGLAIS, Pont de Claix (FR); Christophe LEGRAS, Montbonnot Saint-Martin (FR); Jérôme POUYADOU, Grenoble (FR)

(73) Assignee: Naver Corporation, Gyeonggi-do (KR)

(21) Appl. No.: 17/584,973

(22) Filed: Jan. 26, 2022

Related U.S. Application Data
(60) Provisional application No. 63/170,456, filed on Apr. 3, 2021.

(51) Int. Cl. G01C 21/36; G01C 21/34

(52) U.S. Cl. CPC G01C 21/3644; G01C 21/3682; G01C 21/3476; G01C 21/3647; G01C 21/3602; G01C 21/3446

(57) ABSTRACT

There is provided an approach for using street view images, captured from a selected geographical area, to obtain one or more of a landmark saliency score and a street crossing simplicity score, with each score reflecting a degree to which a computer-implemented circuit (including image recognition engines and a visual element matching module) can recognize and identify a landmark in at least one of the street view images. In turn, a navigational plan for a selected geographical area, including travel directions, is generated with the one or more of the landmark saliency score and the street crossing simplicity score.

### PRIORITY INFORMATION

The present application claims priority, under 35 USC §119(e), from US Provisional Patent Application, Serial Number 63/170,456, filed on Apr. 3, 2021. The entire content of US Provisional Patent Application, Ser. No. 63/170,456, filed on Apr. 3, 2021, is hereby incorporated by reference.

### FIELD

The presented disclosure generally relates to a machine-based technique for recognizing and identifying a landmark(s) in a street view image with visual elements associated with the landmark(s) being used to generate navigational plans.

### BACKGROUND

Points of interest or landmarks, as geographical cues, serve as salient objects that are easy to recognize, represent or describe. Their salience triggers multiple human capabilities and induces various behaviors. For example, representation capabilities of landmarks at various levels of abstraction levels, such as visual, structural, cognitive and prototypical representations of a related environment, may give rise to a form of expectation—this is sometimes referred to as “visibility in advance.” These abstraction levels interact with one another to define the overall salience of the landmark, thus resulting in a strong impression of the landmark, with respect to both visual salience and cognitive representations, in the human cortex.

In urban areas, visual elements associated with landmarks, such as images, logos and text are ubiquitous. Landmark signage can provide a human with considerable information about the nature of the corresponding landmark, assisting, for instance, in categorizing landmark type. Specific features of landmark signage, such as related text or logos, may overcome other salient features as primary attractors of attention. Accordingly, since the text or logo of signage generates strong cues for localization and orientation, it is often quite salient in identifying the landmark to which it refers.

Various methods for recognizing text and/or logos with respect to landmark related images are known. Moreover, use of image or text recognition to facilitate navigation and localization is known.

In the context of navigation, one known navigation approach employs a robust text extraction algorithm to facilitate the detection of indoor text-based landmarks, such as door nameplates and information signs. Another known navigation approach discloses a text detection algorithm, employing artificial intelligence, to improve landmark recognition. Yet another known navigation approach employs a deep learning technique for recognizing French street name signs. While these approaches may serve to improve landmark recognition during navigation, they do not necessarily accommodate for how a human actually perceives a given landmark pursuant to navigation.

In the context of localization, U.S. Patent Application Publication No. 2020/0378786, the entire disclosure of which is incorporated herein by reference, discloses a method for generating access maps for a given destination using points of interest (POIs) to facilitate orientation and wayfinding (e.g., by disambiguating complex crossings) without the need of specifying a starting location. The method includes listing path or street crossings through which computed access paths cross. For each crossing, the probability that the listed crossing is passed through by an access path is evaluated and at least one complexity rating is calculated. Each crossing has a level of difficulty based at least in part on (i) the physical configuration of the crossing and (ii) to the traversal of the crossing in terms of inbound and outbound paths. A crossing's complexity score is based on one or more of the following parameters: (1) the number of inbound and outbound paths at the crossing; (2) the need to change direction in the crossing; and (3) the existence of confusing paths.

In addition to using a complexity rating to generate an access map, U.S. Patent Application Publication No. 2020/0378786 discloses the calculation of a POI quality score for selecting POIs with respect to a listed crossing. However, the complexity rating does not necessarily accommodate for how a human actually orients himself with respect to one or more points of interest associated with the listed crossing.

There is therefore a need for a machine-based approach for identifying landmarks or points of interest, in accordance with how such landmarks or points of interest might actually be perceived by human beings, for purposes of generating navigational plans.

### SUMMARY

In a first embodiment there is provided a computer-implemented method for generating a navigational plan for a user in a geographical area that includes a plurality of streets upon which at least one point of interest is present. The computer-implemented method includes: generating one or more travel directions with a landmark saliency score for the at least one point of interest, the landmark saliency score representing a measure reflecting a degree to which a computer-based image recognition system can recognize a visual element in at least one electronic image, the visual element in the at least one electronic image serving to identify the at least one point of interest; and outputting the navigational plan that includes the one or more travel directions; and wherein the generating obtains the landmark saliency score for the at least one point of interest from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.

In one example of the first embodiment, the visual element in the at least one electronic image may be a text portion or a logo. When the visual element is a logo, the computer-based image recognition system recognizes the logo with a logo recognition engine. When the visual element is a text portion, the computer-based image recognition system recognizes the text portion with a text recognition engine.

In another example of the first embodiment, determining that a selected relationship exists includes using image matching to determine whether the selected relationship exists between the visual element in the at least one electronic image and the previously stored visual element. The image matching may include using fuzzy matching to determine that the selected relationship exists between a text portion in the at least one electronic image and a text portion in the previously stored visual element.

In yet another example of the first embodiment, the method further includes: determining, responsive to said comparing, that an image match exists between the visual element in the at least one electronic image and the previously stored visual element; responsive to said determining that the image match exists, assigning an image match score; and wherein said determining that a selected relationship exists includes determining that the image match score is equal to or greater than a selected image match threshold. The obtaining of the landmark saliency score may further include assigning a cognitive score to the at least one point of interest, the cognitive score reflecting a degree to which the at least one point of interest would be identified by a human in accordance with common knowledge of points of interest. The at least one point of interest with the cognitive score may be stored in a database.

In another example of the first embodiment, the landmark saliency score varies as a function of the image match score, the cognitive score and a distance calculated from at least one of the plurality of electronic images. The distance calculated from at least one of the plurality of electronic images corresponds with a maximized user recognition limit. Additionally, the geographical area may include a plurality of neighborhoods of varying respective sizes and the landmark saliency score may be normalized to accommodate for differences in neighborhood size. Finally, the landmark saliency score may be selected from a list of ranked landmark saliency scores.

In a second embodiment there is provided a computer-implemented method for generating a navigational plan for a user in a geographical area that includes a plurality of streets with at least two of the streets forming a street crossing. The computer-implemented method includes: generating one or more travel directions with a street crossing simplicity score, the street crossing simplicity score representing a measure reflecting a degree to which a computer-based image recognition system can recognize a visual element in at least one electronic image, the visual element in the at least one electronic image serving to identify at least one point of interest within a selected distance of a location associated with the street crossing; and outputting the navigational plan that includes the one or more travel directions; wherein the generating obtains the street crossing simplicity score from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.

In one example of the second embodiment said generating at least one of the plurality of travel directions includes (a) generating a plurality of navigational plans, and (b) selecting a navigational plan, from the plurality of navigational plans, that optimizes both ease of street crossing traversal and total travel time. To develop one navigational plan: a simplicity score is calculated for one or more street crossings in each one of the plurality of navigational plans, and an estimated total travel time is calculated for each one of the plurality of navigational plans, wherein said selecting a navigational plan includes selecting a navigational plan in which both the simplicity score is maximized and the total travel time is less than or equal to a selected maximum acceptable travel time. To develop another navigational plan: for each one of a plurality of navigational plans, a traversal time for each pertinent street crossing and each pertinent road segment time are determined, and for each one of the plurality of navigational plans, an estimated travel time is equal to the sum of all pertinent street crossing traversal times and all pertinent road segment times, wherein said selecting a navigational plan includes selecting the navigational plan with a minimum estimated travel time.

In another example of the second embodiment, the visual element in the at least one electronic image is one of a text portion and a logo. When the visual element is a logo, the computer-based image recognition system recognizes the logo with a logo recognition engine. When the visual element is a text portion, the computer-based image recognition system recognizes the text portion with a text recognition engine.

In yet another example of the second embodiment, determining that a selected relationship exists includes using image matching to determine whether the selected relationship exists between the visual element in the at least one electronic image and the previously stored visual element. The image matching may include using fuzzy matching to determine that the selected relationship exists between a text portion in the at least one electronic image and a text portion in the previously stored visual element.

In yet another example of the second embodiment, the computer-implemented method further includes: determining, responsive to said comparing, that an image match exists between the visual element in the at least one electronic image and the previously stored visual element; responsive to said determining that the image match exists, assigning an image match score; and wherein said determining that a selected relationship exists includes determining that the image match score is equal to or greater than a selected image match threshold. The obtaining of the landmark saliency score may further include assigning a cognitive score to the at least one point of interest, the cognitive score reflecting a degree to which the at least one point of interest would be identified by a human in accordance with common knowledge of points of interest in general.

In yet another example of the second embodiment, said obtaining of the street crossing simplicity score further comprises calculating a visibility score for each identifiable point of interest around at least one street crossing; the visibility score varies as a function of the image match score, the cognitive score and a distance parameter; and for each one of the plurality of electronic images, the distance parameter is defined as the distance between a geographic location associated with the electronic image and a corresponding street crossing location.

In another example of the second embodiment, a plurality of visibility scores are calculated for one street crossing, wherein the street crossing simplicity score for the one street crossing is obtained by adding the plurality of visibility scores together.

In a third embodiment there is provided an apparatus for generating information relating to at least one point of interest from a plurality of electronic images, the information relating to the at least one point of interest being usable to generate a plurality of travel directions. The apparatus includes: an image recognition platform for performing image recognition on at least one of the plurality of electronic images to identify at least one of a text portion and a logo; an image matching module for comparing the at least one of the text portion and the logo with each text portion or logo in a points of interest database to obtain an image recognition score for the at least one of the text portion and the logo; said image matching module determining whether a selected relationship exists between the at least one of the text portion and the logo and at least one point of interest designated in the points of interest database; a cognitive scoring module, said cognitive scoring module assigning a cognitive score to a point of interest corresponding with the at least one of the text portion and the logo when the selected relationship exists, the cognitive score reflecting a degree to which the point of interest corresponding with the at least one of the text portion and the logo can be identified by a human in accordance with common knowledge of points of interest; and an enhanced points of interest database, the point of interest corresponding with the at least one of the text portion and the logo being stored in said enhanced points of interest database.

In one example of the third embodiment, the image recognition score for the at least one of the text portion and the logo is greater than or equal to a selected threshold. Additionally, when the at least one of a text portion and a logo comprises a text portion, fuzzy matching can be used to determine whether the selected relationship exists between the text portion and at least one point of interest designated in the points of interest database.

In another example of the third embodiment, the information relating to the at least point of interest includes one of a landmark saliency score and a street crossing simplicity score, each of one of the landmark saliency score and street crossing simplicity score representing a measure reflecting a degree to which said image recognition module recognizes the at least one of the text portion and the logo in one of the plurality of electronic images.

In yet a further embodiment, there is provided a computer-implemented method for generating a navigational plan for a user in a geographical area that includes a plurality of streets (a) upon which at least one point of interest is present and (b) with at least two of the streets forming a street crossing. The computer-implemented method includes: generating one or more travel directions using one or more of (x) a landmark saliency score for the at least one point of interest, the landmark saliency score representing a measure reflecting a degree to which a computer-based image recognition system can recognize a visual element in at least one electronic image, and (y) a street crossing simplicity score, the street crossing simplicity score representing a measure reflecting a degree to which a computer-based image recognition system can recognize a visual element in at least one electronic image, the visual element in the at least one electronic image serving to identify, respectively, (v) the at least one point of interest, or (w) at least one point of interest within a selected distance of a location associated with the street crossing; and outputting the navigational plan that includes the one or more travel directions; wherein said generating obtains one or more of the landmark saliency score for the at least one point of interest and the street crossing simplicity score from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.

### DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a block diagram of a computer-implemented circuit used to implement the disclosed embodiments;

FIG. 2 is a flowchart illustrating an exemplary process performed with the system of FIG. 1;

FIG. 3 is schematic view of a marked-up map of a north part of Grenoble, France, the marked-up map illustrating the respective locations of points of interest and locations where street view images were captured;

FIG. 4 is a schematic view of a map of the north part of Grenoble illustrating buildings and streets from which street view images were obtained;

FIG. 5 is a diagram accompanying a calculation of a landmark_score_{POI};

FIG. 6 is a marked-up map of FIG. 4 where each building including at least one point of interest identifiable from a street is shown in color;

FIG. 7 is an enlarged portion of FIG. 6, illustrating the portion within the rectangle 602 of FIG. 6;

FIG. 8 illustrates landmark scores as a heat map on the geographical map of

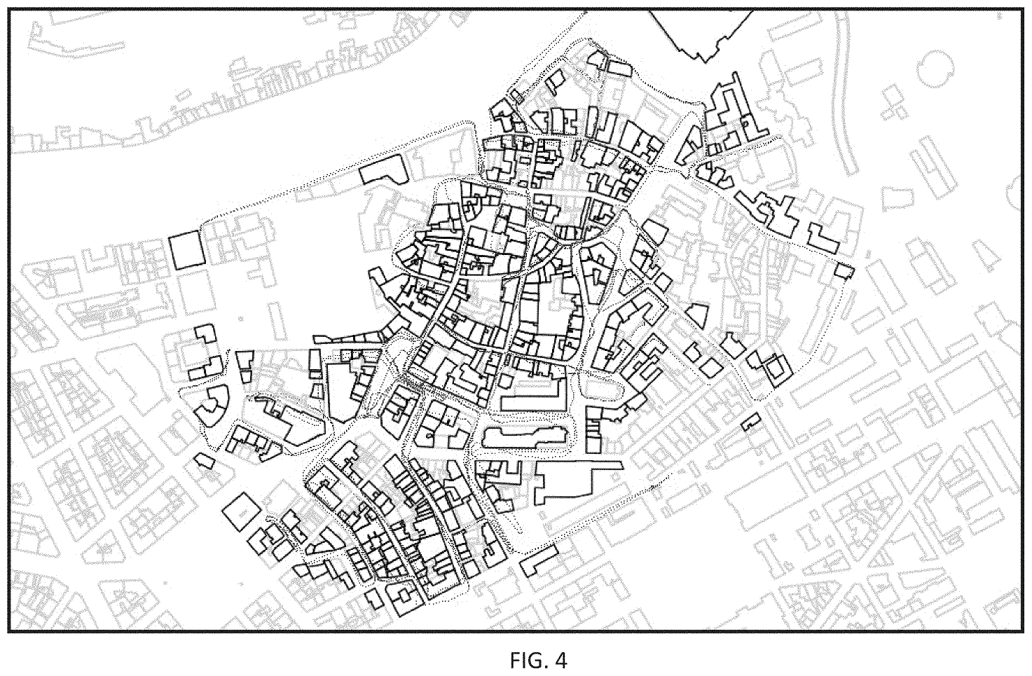

FIG. 4, where magenta is the highest score and cyan is the lowest;

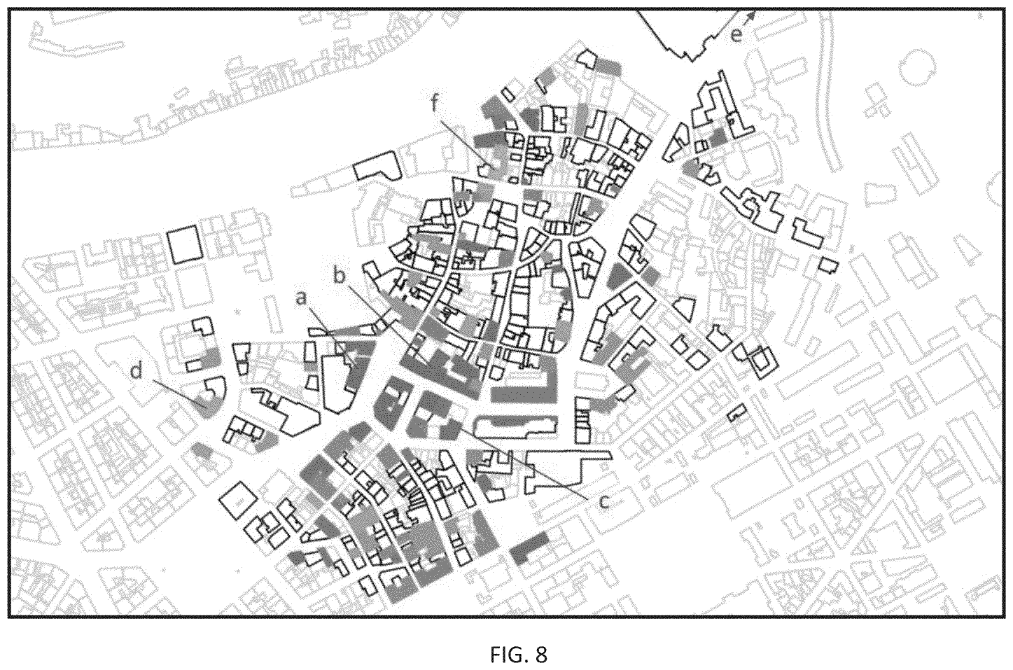

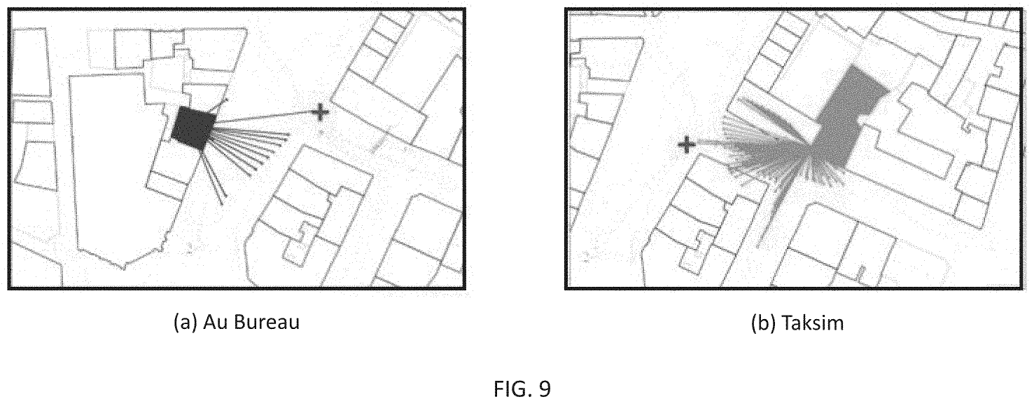

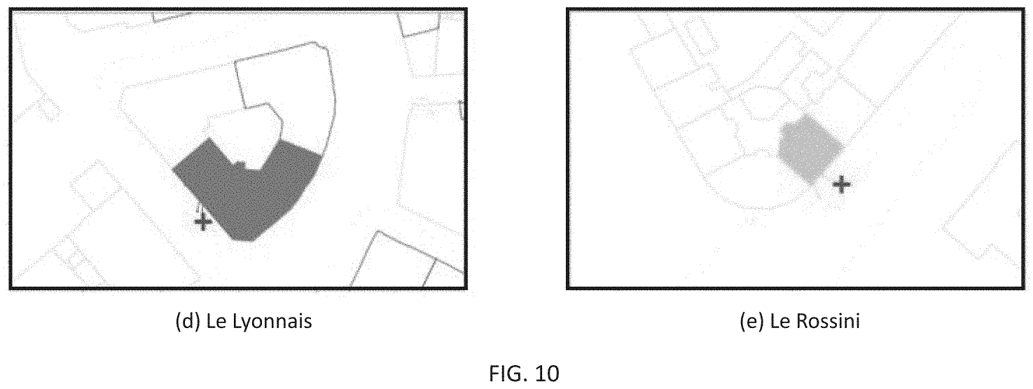

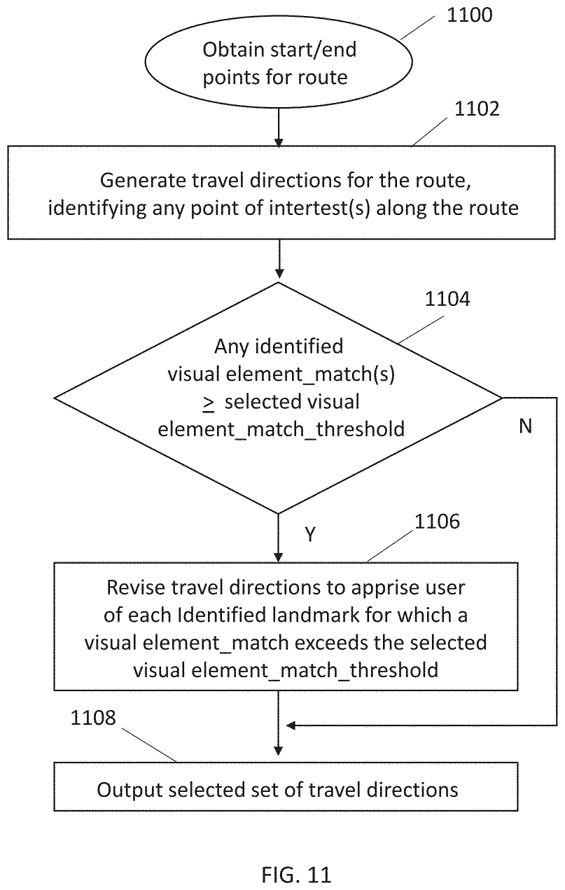

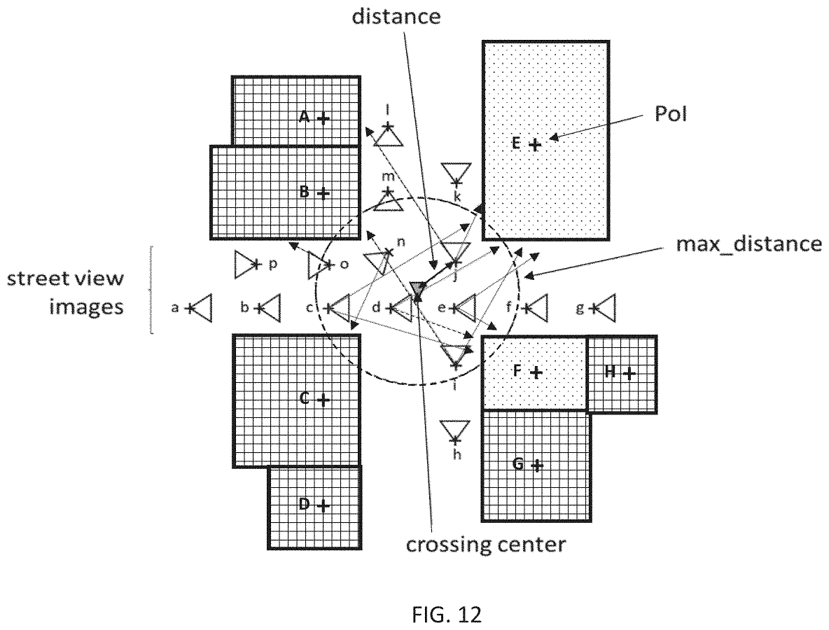

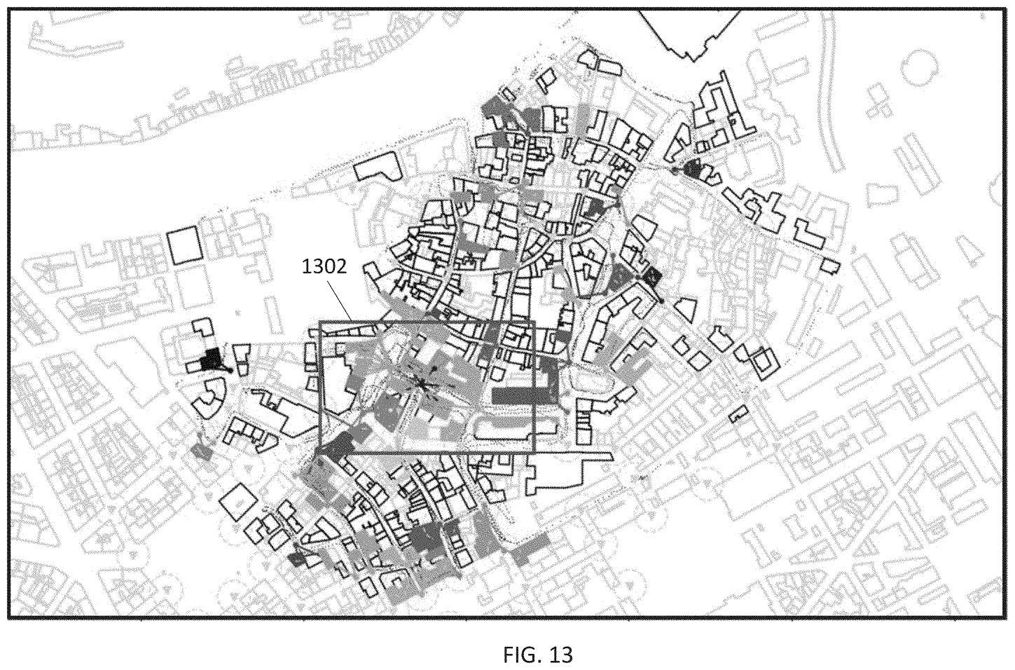

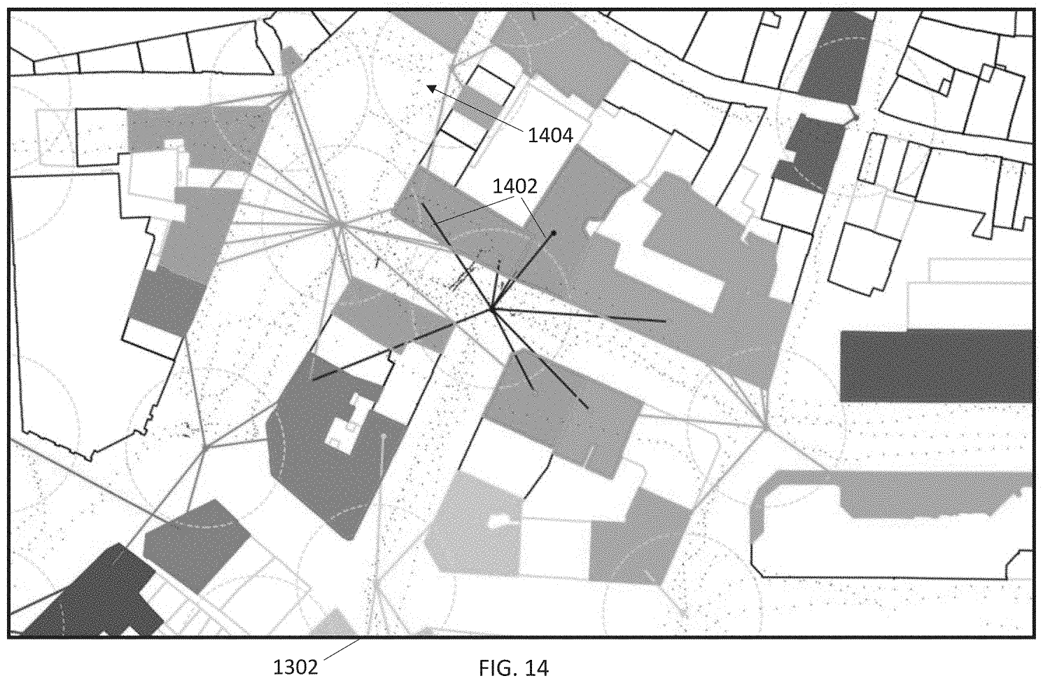

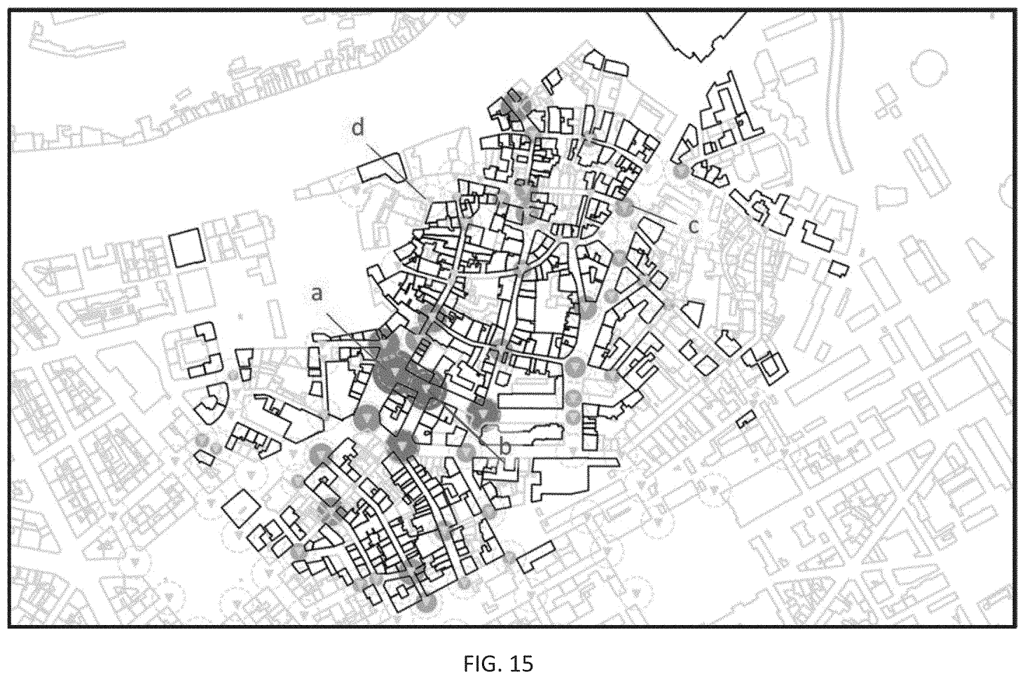

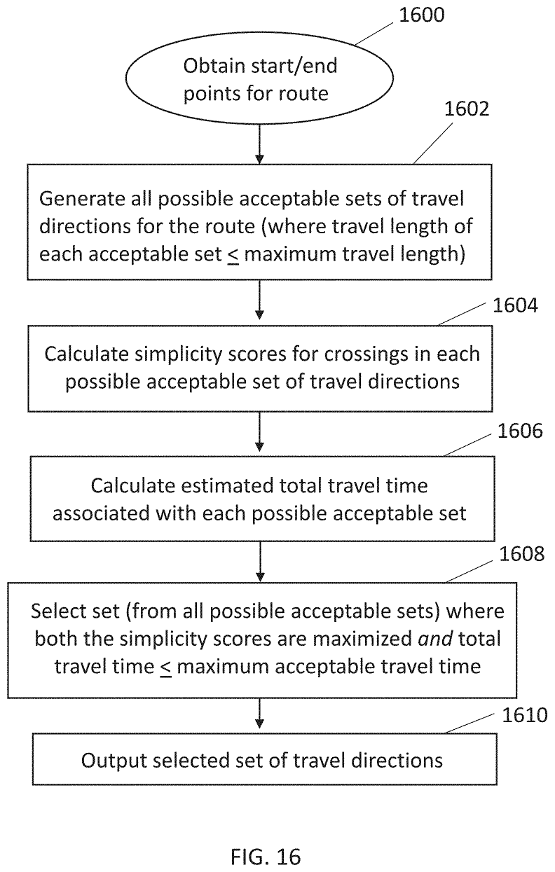

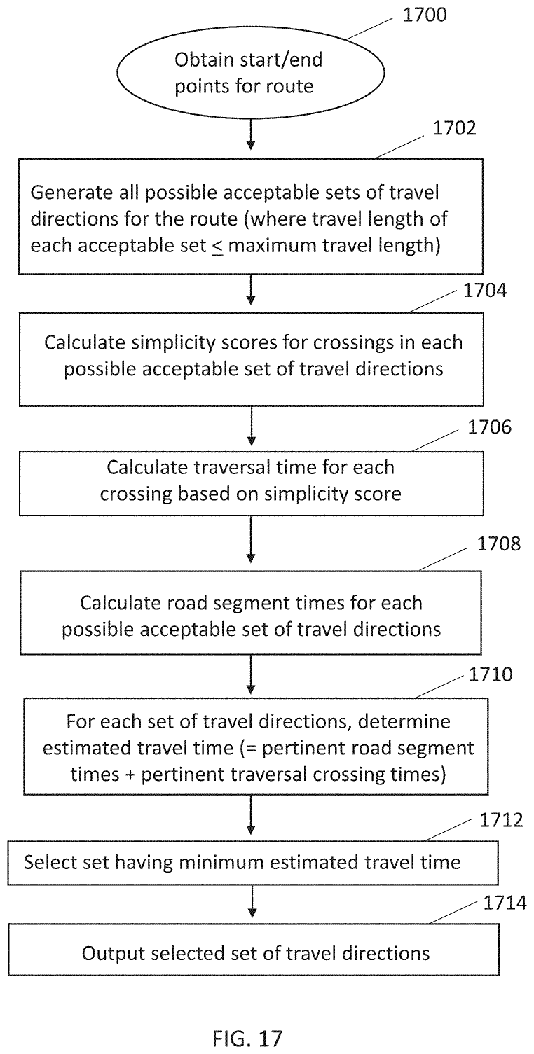

FIG. 9 illustrates planar, schematic views of respective street view images (designated as “a” and “b” in FIG. 8) where each recognized POI is shown in color;

FIG. 10 illustrates planar, schematic views of respective street view images (designated as “d” and “e” in FIG. 8) where each recognized POI is shown in color;

FIG. 11 is a flowchart illustrating an exemplary process for generating a navigational plan (i.e., travel directions) with the above-described landmark_score_{POI};

FIG. 12 is a diagram accompanying a calculation of a street crossing simplicity score;

FIG. 13 illustrates the map of FIG. 4 in which buildings hosting POIs identifiable from street crossings are highlighted in color;

FIG. 14 is an enlarged portion of FIG. 13, illustrating the portion within the rectangle 1302 of FIG. 13—relationships between identifiable POIs and street crossings are shown with lines (e.g., 1402) and all street view image positions are represented with dots (e.g., 1404);

FIG. 15 is a street crossings heat map of FIG. 4 in which magenta colored crossings possess higher simplicity scores, while cyan colored crossings possess lower simplicity scores;

FIG. 16 is a flowchart illustrating one exemplary process for generating travel directions with street crossing simplicity scores; and

FIG. 17 is a flowchart illustrating another exemplary process for generating travel directions with street crossing simplicity scores.

In the drawings, reference numbers may be reused to identify similar and/or identical elements.

### DETAILED DESCRIPTION

### 1. System Implementation

It should be appreciated that the disclosed embodiments can be implemented in numerous ways, including as a process, an apparatus, a system, a device, a method, or a computer readable medium such as a computer readable storage medium containing computer readable instructions or computer program code, or a computer network wherein computer readable instructions or computer program code are sent over communication links. Applications, software programs or computer readable instructions may be referred to as components or modules. Applications may take the form of software executing on a general-purpose computer or be hardwired or hard coded in hardware. Applications may also be downloaded in whole or in part through the use of a software development kit, framework, or toolkit that enables the creation and implementation of the disclosed embodiments. In general, the order of the steps of disclosed processes may be altered within the scope of the disclosed embodiments.

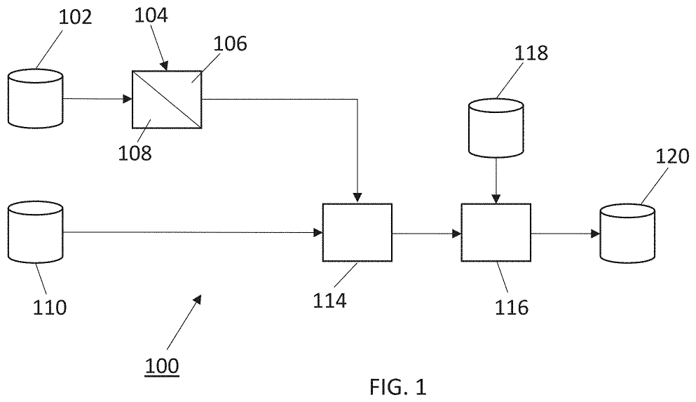

Referring to FIG. 1, a computer-implemented circuit for generating a database of enhanced points of interest is designated with the numeral 100. The computer-implemented circuit 100, in one embodiment, includes one or more processors and a memory 102 for storing images obtained from selected locations in a selected geographical area (“street view images”). As illustrated in FIG. 1, the memory 102 communicates with a visual element recognition platform 104, the visual element recognition platform 104 including both a text element recognition engine 106 and an image element recognition engine 108 for respectively recognizing text and images in the street view images. As used herein, the term “visual element,” refers to an image or text portion associated with a POI (or landmark). As contemplated by the embodiments, a street view image may include several visual elements, such as a text element and/or a logo element. As will be appreciated by those skilled, a logo element can be recognized by either the text element recognition platform 106 and/or the image element recognition platform 108.

The text element recognition engine 106 employs optical character recognition (OCR), a well known approach, capable of being programmed to automatically read text in a street view image. OCR techniques use various approaches to segment images for locating textual areas, sequencing each character found in those textual areas, and recombining them to understand the word made by these characters. One OCR approach, as demonstrated by Akbani, A., Gokrani, A., Quresh, M., Kahn, F. M., Behim, S. I. and Syed, T. Q. Character Recognition in Natural Scene Images, 2015 ICICT 2015, the entire disclosure of which is incorporated herein by reference, is effective for recognizing text in images of natural scenes. Another OCR approach, as demonstrated in U.S. Pat. No. 9,008,447, the entire disclosure of which is incorporated herein by reference, is effective for recognizing text in printed documents.

These types of OCR approaches are typically dependent on text contrast, representation, distance and orientation with respect to a capture device with which they are used (such as a camera). This may result in occasional erroneous recognition or misspelling of words. Such error can be quite similar to how a human recognizes and reads a text: one may erroneously recognize text if it is too small, too far, too fancy or distorted by perspective. As follows from the subject Description, the disclosed embodiments use the text recognizing aspect of the text recognition engine 106 to mimic human text recognition in a natural scene, accommodating for its technical limitations (misrecognized text).

The image element recognition engine 108 can employ one of several known techniques for recognizing logos in street view images. In one example, as disclosed in U.S. Pat. No. 9,508,021, the entire disclosure of which is incorporated herein by reference, the image element recognition engine 108 uses techniques for recognizing similarities among two or more images. Local features of a given street view image may be compared to local features of one or more reference images to determine if local features of the given street view image comprises a particular pattern to be recognized.

In another example, the image element recognition engine 108 could suitably use, as disclosed in U.S. Pat. No. 10,007,863, the entire disclosure of which is incorporated herein by reference, saliency analysis, segmentation techniques, and character stroke analysis. Saliency detection relies on the fact that logos have significant information content compared to the background. Multi-scale similarity comparison is performed to remove less interesting regions such as text strings within a sea of text or other objects.

In yet another example, the image element recognition engine 108 could suitably use a machine learning based approach for detecting logos in video or image data of the type disclosed in U.S. Pat. No. 10,769,496, the entire disclosure of which is incorporated herein by reference.

Although the above-mentioned examples of logo recognition focus on techniques for recognizing logos, logo recognition may be considered a subset of object or pattern recognition. Typically, logos may include a variety of objects having a planar surface. Accordingly, although embodiments described may apply to logos, images, patterns, or objects, claimed subject matter is not limited in this respect. A process of computer recognition may be applied to recognizing a logo, a geometrical pattern, an image of a building in a photo, lettering, a landscape in a photo, or other such object of an image or photo, just to name a few examples.

Referring still to FIG. 1, a database including a plurality of POIs for a selected geographical area, such as Grenoble, France, is designated with the numeral 110. The database 110 can be developed from either scratch (with information from the selected geographical area) or with an off-the-shelf product, such Open Street Map (OSM). When using OSM, entries are organized by way of POI name, POI type/amenity and POI location. Additionally, in one exemplary approach, the

POI database is enhanced with logos from an off-the-shelf logo database.

Visual element recognition platform 104 and POI database 110 communicate with a visual element matching module 114. In the embodiments, the visual element matching module 114 could include one or more image matching subsystems of the type disclosed in U.S. Pat. No. 8,315,423, the entire disclosure of which is incorporated herein by reference. In the embodiments, visual element matching module 114 could employ fuzzy matching logic of the type disclosed in U.S. Pat. No. 8,990,223, the entire disclosure of which is incorporated herein by reference. The purpose of the visual element recognition module 114, as will appear, is to determine if a sufficient match exists between a visual element in a street view image and a visual element listed in the database 110.

Results from the visual element matching module 114 are communicated to a cognitive scoring module 116. The cognitive matching module 116 serves to classify the output of the visual element matching module 114 with a POI categories dictionary 118. The POI categories of the dictionary can be obtained from OSM or developed from scratch. A cognitive score resulting from the classification reflects how readily a given POI is recognized by a human according to the knowledge the human would typically posses with respect to the given POI. For instance, a higher cognitive score would be assigned to a fast food restaurant than to a cleaning service agency.

Information from the cognitive scoring module 116, regarding enhanced POls, is communicated to an enhanced POI database 120.

### 2. System Functionality

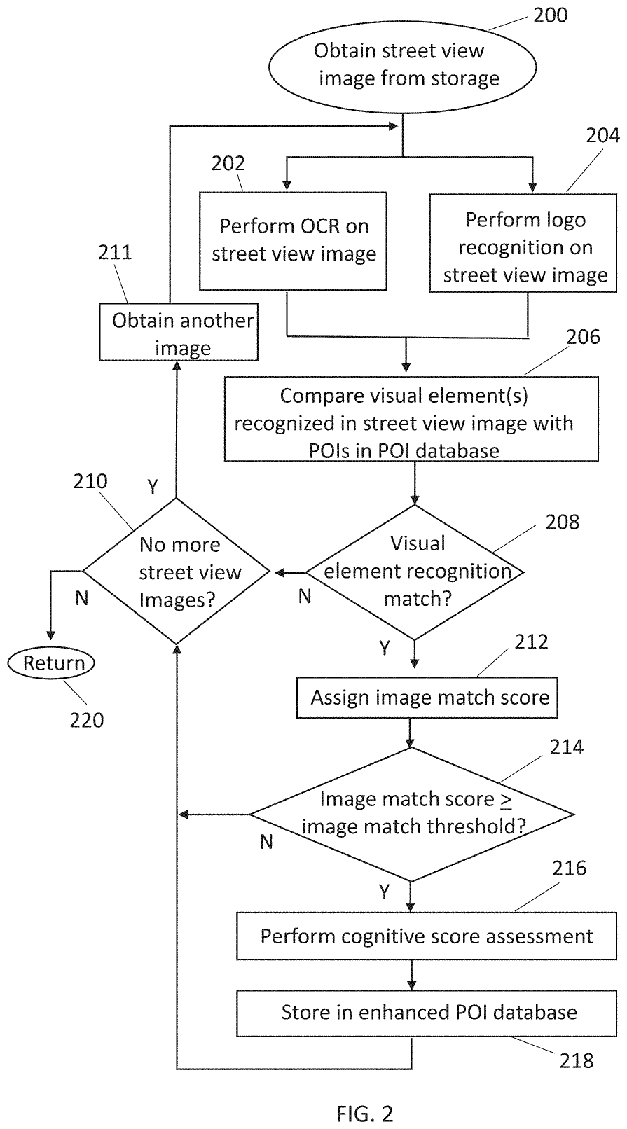

Referring to FIG. 2, the function of computer-implemented system 100 of FIG. 1 is described. In the embodiments, street view images from a selected geographical area are stored in memory 102. In one embodiment, the street view images are captured with a vehicle traversing through the selected geographical area and collecting street view images with GPS coordinates. The processing of a street view image begins at 200 by obtaining one of the street view images from memory 102.

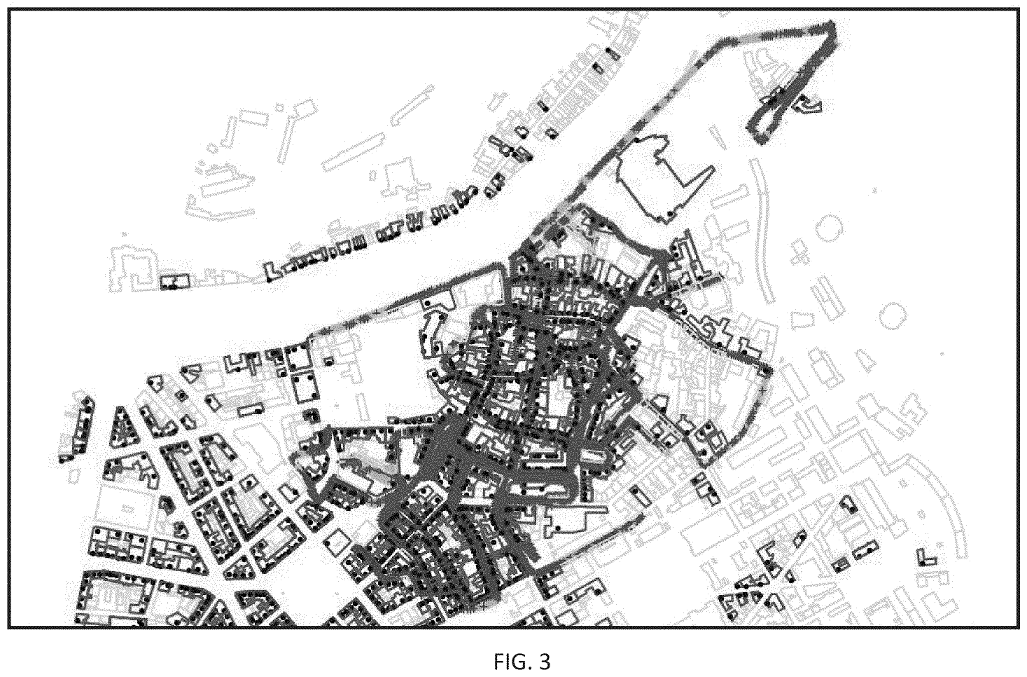

Referring to FIG. 3, a marked-up map of the north part of Grenoble is used to illustrate an experimentation relating to the embodiments. The map includes POIs (represented by black dots) and buildings (colored in gray). Buildings hosting POIs are shown in red, street view images are shown in cyan, and each street view image with at least one visual element recognized is shown in blue. The POIs were ascertained by reference to OSM and relate to the urban center of Grenoble by suitable focus on name, type/amenity and coordinates. The buildings were ascertained by reference to the Institut Geographique National (IGN). In the experimentation, the vehicle, which includes a bicycle having four cameras (back, front, left, right), traverses through the streets of the north part of Grenoble, and collects an appropriate number of street view images with GPS coordinates. In an alternative approach, a crowdsourcing approach where, for instance, delivery vehicles provided with cameras and GPS capability could be used to obtain even further quantities of street view images.

The experimentation generally focused on, among other things, two constraints: buildings hosting POIs and streets covered by street view images. Intersection between these two constraints is illustrated by FIG. 4 where (a) buildings hosting POIs are shown in black, (b) buildings lacking POIs are shown in gray, and (c) streets traversed for obtaining street view images are shown by dotted blue lines. Quantitatively, for the experimentation, 359 buildings hosting 652 POIs were considered.

Referring again to FIG. 2, at 202, 204 text portion recognition (comprising OCR) and logo recognition are performed on a stored street view image. In 206, a comparison between the recognized visual element(s) of the street view image and each POI listed in the POI database 110 is performed to determine if a sufficient “match” (i.e., a selected relationship) exists between the recognized visual element(s) and one or more of the POIs.

In one example, the comparison is performed with fuzzy logic; however, as indicated above, other visual element matching technologies could be employed to rate the extent to which the recognized visual element(s) corresponds to at least one of the POls in the POI database 110. Referring to 208, if no match exists between a recognized visual element(s) and a given POI, then the system determines, at 210, if processing of additional street view images is warranted. If further processing of street view images is warranted, then another image is, via 211, fetched from memory 102. If, on the other hand, all currently stored street view images have been assessed with respect to the POI database 110, then the process ends at 220 until additional street view images are supplied to the memory 112.

Referring still to FIG. 2, for each match determined per 208, a visual element_match score is assigned at 212 and each match is represented as “street view image —POI” pair (“Pair”). At 214, each visual element_match score of a given Pair is compared with a visual element_match_threshold. The system filters out any Pair having a visual element_match score lower than the visual element_match_threshold. For each instance in which a visual element_match score is found to be lower than the visual element_match_threshold, the system determines, at 210, whether further assessment of street view images is warranted.

Each pair having a visual element_match score equal to or greater than the visual element_match_threshold is passed along to the cognitive scoring module 116. By way of 216, the POI of each Pair having a suitable visual element_match score is classified in accordance with the POI categories dictionary 118 and an appropriate cognitive_score reflecting such classification is assigned. As will be appreciated by those skilled in the art, other approaches, such as crowdsourcing, could be employed to rate the degree to which various POls are recognizable, based on common knowledge.

Each fully scored street view—POI pair is, via 218, stored in the enhanced POI database 120. In one embodiment, a new cross table is available on the enhanced POI database, pairing street view images with POIs through its visual element_match score and coginitive_score. It is further contemplated that street view images and their locations, as well as POI name, category and location are also available in the database 120. As described below, with the information stored in database 120 (FIG. 1), calculation and storage of both a landmark_score (for a building) and a visibility_score (for a POI in a geospatial database) are made possible.

a. Scoring Buildings as Relevant Landmarks

In one example, the landmark_score corresponds with a POI (such as a building) on a map. The landmark_score (also referred to herein as “saliency score”) represents, among other things, the capability of a POI to be easily recognized and identified as a landmark by a human. As will appear form the following, that capability can be assessed from the capacity of the system 100 to recognize, from street view images, visual elements (e.g., text and/or logos) associated with POls. The landmark_score varies as a function of the following three parameters, the three parameters being extractable from the enhanced POI database 120 (FIG. 1):
i) Visual element_match is both obtained from the enhanced POI database 120 (and thus exceeds the visual element_match_threshold) and includes a match percentage, (e.g., ≥80%; which, in one embodiment, is obtained by way of fuzzy matching). The visual element_match_threshold is set so that the resulting visual element_match score complies with human recognition.
ii) Cognitive_score is defined above.
iii) Distance corresponds with a recognition limit at which both a selected POI can just be suitably recognized (from a street view image) and has an visual element_match score≥the visual element_match_threshold.

In another example, the landmark_score for a selected POI may be expressed as the maximum of the product of the three parameters:

Landmark_score_{POI}=max (visual element_match score×cognitive score×distance)

As can be recognized, in the above exemplary formula, Landmark_score_{POI} is maximized when a good visual element match can be obtained from a relatively long distance. While the above formula expresses the three parameters as a product with no weighting, in another example, each of the three parameters could be weighted to accommodate for perceived importance.

Also, a landmark score for a given building including a POI may be defined as follows:

Landmark_score_{Building}=max (Landmark_score_{POI}) [when POI is in a building]

b. Exemplary Application of Scoring Buildings as Relevant Landmarks

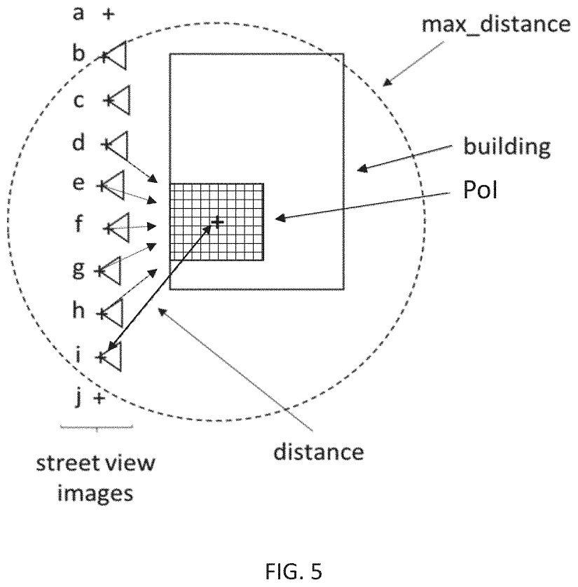

Referring to FIG. 5, an exemplary approach for assessing a set of street view images appropriate for use in determining a Landmark_score_{POI} (i.e., a landmark saliency score) is illustrated. The exemplary approach limits false positive POls by using both a visual element_match exceeding a selected visual element_match_threshold and at least nb_images (i.e., a preset minimum of street view images):

The exemplary approach includes a set of street view images a-j. In accordance with the embodiments, this set of street view images is filtered as follows:
(i) Street view images “close” to the POI (i.e., distance<max_distance): [b-i];
(ii) Street view images for which visual element_match>visual element_match_threshold: [e,f,g] (note that street view images with matches correspond with dotted lines and non-matching street view images correspond with dashed lines.
(iii) Number of street view images recognizing one POI>nb_images: [e,f,g]

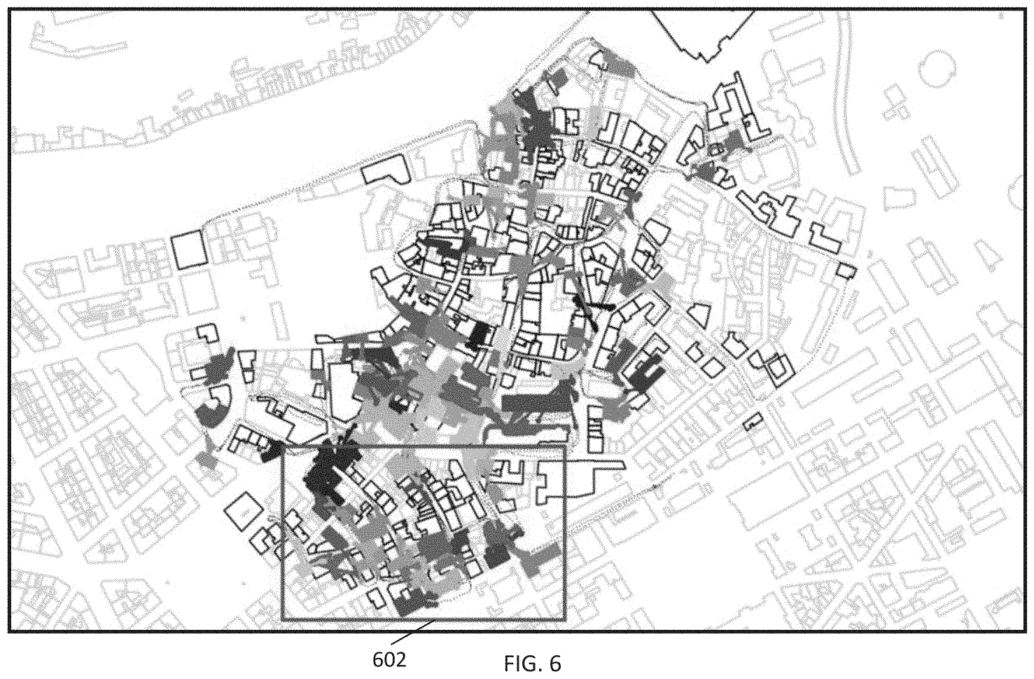

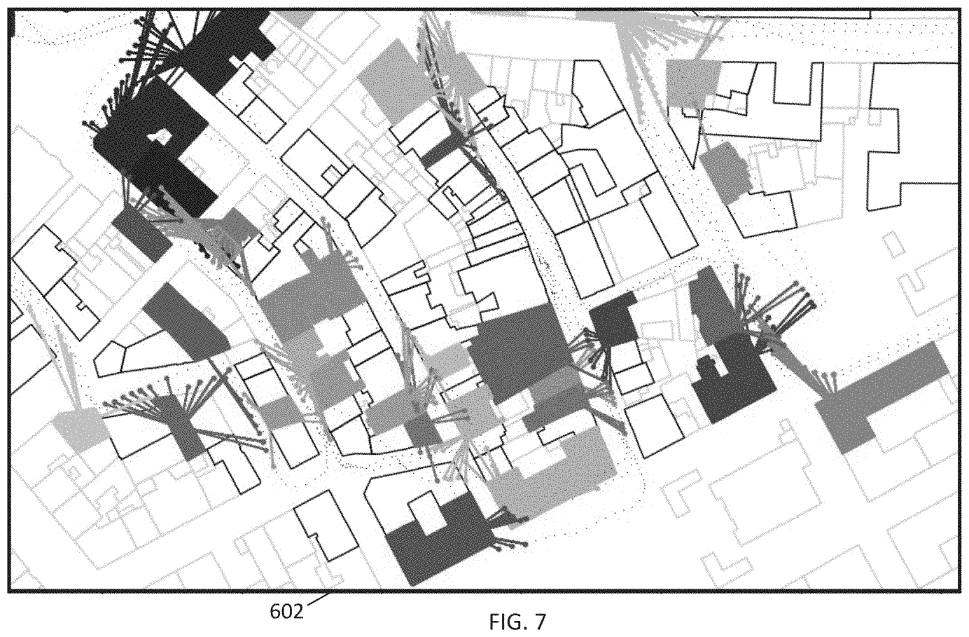

Referring to FIG. 6, buildings containing at least one recognized POI are illustrated with various colors. Each colored building is recognizable in nb_images (e.g., at least three different street view images) as matching a POI related visual element with at least 80% certainty. In one example, OCR recognition using the text recognition engine 106 (FIG. 1) yields a match of at least 80%, indicating a minimum of mismatched characters—meaning that the POI (with its corresponding, recognized visual element[s]) is readily identified by a human. FIG. 7 is an enlarged portion of FIG. 6 (the portion within the rectangle 602) further illustrating the nb_images (represented by colored points and connecting lines) and the associated building (represented using the same color as the colored lines representing the association with the colored points) including a visual element for which a visual element recognition of at least 80% has been obtained.

Using the exemplary formulas above for determining landmark_score_{POI} and landmark_score_{Building}, FIG. 8 illustrates landmark scores as a heat map on the geographical map of FIG. 4 (with the gray outlined buildings being omitted). In the heat map, magenta is the highest score (in terms of visual element matching), while cyan is the lowest. The map of FIG. 8 illustrates a relationship between a given POI and the size of the street on which it is located. Consequently, two different POIs with identical signage may be viewed differently based on the openness of the street where they are located. Business owners are generally aware that, for purposes of landmark visibility, being located in a relatively open space (e.g., open street crossing) is preferable to being located on a narrow space (e.g., narrow street). The described embodiments can accommodate for this natural bias in smaller neighborhoods by applying landmark or POI normalization at the scope of a given neighborhood, which normalization can be useful when generating travel directions.

Referring still to FIG. 8, visual element recognition candidates (respectively associated with identifiable POIs) [“candidates”] are respectively designated as “a,” “b,” “c,” “d,” “e” and “f.” Referring specifically to FIG. 9, the two best candidates (a and b) are shown respectively as two planar maps and, referring to FIG. 10, two lesser candidates (d and e) are shown respectively as two planar maps—four planar maps in all. The respective POIs (e.g., buildings) associated with the candidates a, b, d, and e are “Au Bureau,” “Taksim,” “Le Lyonnais,” and “Le Rossini.” Each planar map includes a red “+” symbol indicating the farthest point at which a visual element(s) (e.g., text or logo) associated with a corresponding POI (illustrated as a colored geometric shape) can be recognized. Also, the colored points connected to site lines represent street view images in which the visual element(s) associated the corresponding POI can be readily recognized.

Referring to Table 1 which sets out calculated landmark scores for candidates collected with respect to visual element recognition candidates a, b, c, d, e, and f and the above-described formula was used to calculate Landmark_score_{POI} (referred to in Table 1 as “land_score”):

TABLE 1

| | POI Name | OCR | OCR_Match | cognitive_score | Distance | | land_score |
|---|---|---|---|---|---|---|---|
| a | Au Bureau | AUBUREAU | 94% | 100% | 49 | m | 100% |
| b | Taksim | Taksim | 100% | 100% | 45 | m | 97% |
| c | Monoprix | MONOPRIX | 100% | 90% | 49 | m | 88% |
| d | Le Lyonnais | Lyonnais | 84% | 100% | 9 | m | 16% |
| e | Le Rossini | Rossini | 82% | 100% | 8 | m | 14% |
| f | L'Eau Vive | Eauvive | 82% | 60% | 6 | m | 6% |

Referring still to FIG. 9 and FIG. 10, the significance of the distance parameter to the landmark/POI scoring approach can be more fully appreciated. The distance parameter takes into account how far a human can be from a visual element associated with a landmark (or POI) and still recognize that visual element. Consequently, the respective distances in FIG. 9 are relatively long, because the corresponding visual elements (e.g., text signage) can be recognized at relatively long distances while the respective distances in FIG. 10 are relatively short because the corresponding visual elements can only be recognized at relatively short distances.

c. Using landmark_score_{POI} in Generating Travel Directions

Referring to FIG. 11, an exemplary process for generating travel directions with the above-described landmark_score_{POI} is provided. At 1100, information regarding the route to be taken by a user (specifically including the start and end points for the route) is gathered, preferably through use of a conventional computing device, such as a handheld mobile phone (i.e., “smart” phone). Responsive to receiving such information, the conventional computing device uses a map generating program, at 1102, for both generating a recommended set of driving directions for the route and identifying POIs along the route. Detailed description of the manner in which conventional computing devices generate navigational maps with travel directions is provided in U.S. Pat. No. 6,092,076, the entire disclosure of which is incorporated herein by reference. As indicated in the '076 Patent, information about points of interest is also available for inclusion in computer generated maps. Identifying POIs or landmarks in travel directions are also described in U.S. Pat. No. 7,286,931 and U.S. Pat. No. 10,215,577, the entire respective disclosures of which are incorporated herein by reference.

Referring still to FIG. 11, the process determines, at 1104, whether any of the POIs (e.g., landmarks) indicated in the travel directions include a visual element match of the type described above in which a visual element_match exceeds a selected visual element_match_threshold. In one embodiment, the process is used to determine if an identified landmark includes a landmark saliency score that is equal to or greater than a selected threshold. For each instance in which the landmark saliency score is equal to or greater than the selected threshold, the travel directions are revised, at 1106, to apprise a user of both the existence of the landmark and corresponding visual element (e.g., text and/or logo) with which the landmark is associated. In turn, the travel directions are stored in memory or buffered for eventual output, via 1108.

d. Scoring the Degree of Understandability of a Crossing

In addition to scoring buildings as relevant landmarks, the simplicity of street crossings can be scored by processing street view images (in memory 102 [FIG. 1]) with respect to information stored in POI database 110 (under the respective categories of POI name, POI amenity and POI location). As will appear, the street crossing simplicity score (“simplicity score”) as described herein, can serve to localize and orient a human, with respect to relevant POls at a selected crossing. Calculation of the simplicity score leverages some of the same types of parameters used to calculate the Landmark_score_{POI}, namely visual element_match, cognitive_score and distance. While visual element_match and cognitive_score are defined the same as in the calculation of Landmark_score_{POI}, distance is defined as the distance between the street view image location and a selected location with respect to a street crossing (such as the center of the street crossing). As used in calculating the simplicity score, distance serves to focus street view images around a selected street crossing location. Also note max_distance corresponds with a radius of a boundary circumscribing a crossing.

In calculating a simplicity score for a selected crossing, a visibility score with respect to each identifiable POI around a given crossing may be calculated with the following exemplary formula:

visibility_score_{POI}=max (visual element_match×cognitive_score×(max_distance_distance))

As with the calculation of Landmark_score_{POI}, parameters for calculating visibility_score_{POI} could be weighted to accommodate for perceived importance. The simplicity score for POIs around the crossing is then calculated with the following formula:

simplicity_score=Σ visibility_score_{POI}

Referring to FIG. 12, an exemplary approach for assessing the parameters associated with calculating the street crossing simplicity score is provided. In the exemplary approach, street view images are designated as a-p, and POls are designated as A-H. Also, street view images having respective matches with certain POls are shown with dotted lines, while street view images failing to match with certain POls are shown with dashed lines. For the set of street view images a-j, results are filtered as follows:
(i) located close to crossing center−distance<max_distance : [c, d, e, l, j, n, o];
(ii) for which visual element_match≥visual element_match_threshold : [c: E & F, d: E & F, e: E & F, is E, j: E, n: C ]; and
(iii) number of image identifying one PO1>nb_images : [E: c, d, e, i, j; F: c, d, e]

As described below, the simplicity score can be advantageously used in travel planning (e.g., generating travel directions). One goal would be to generate travel directions promoting use of crossing with higher simplicity scores. Indeed, the prior art teaches that a typical user will accept up 16% longer trip time if the recommended path is simpler to follow. When assessing what crossings to include in a given route, one possible consideration is the extra time associated with traversing each crossing. The simplicity score can be applied to this extra time by reducing it proportionality. For instance, the simplest crossing in an urban area would have no extra time, while a less simpler crossing or a crossing without a simplicity score would require maximum extra time.

The time required to traverse a given crossing can be simplified by the following exemplary expression (noting that the expression does not accommodate for the impact of such impairments as traffic level or signs):

Crossing Traversal Time=crossing_size×speed⁻¹+structural_complexity×extra_time×(1−normalized_simplicity_score)
Where,
   (i) Crossing_size varies as a function of the physical size of the crossing;
   (ii) Speed is the average speed of the user;
   (iii) Structural_complexity varies as a function of the structural complexity of the crossing; and
   (iv) Extra_time is an estimated constant based on crossing complexity

### d.1 Exemplary Application of Scoring the Degree of Understandability of a

Crossing

Referring to FIG. 13, buildings containing at least one POI are shown in color. Each POI was recognized in three different street view images (nb_image) in a range of 20 m with respect to a crossing center, and possessed a visual element_match of at least 80%. This means, in terms of at least text recognition, that the text associated with each POI contained only one or two mismatched characters, and that the POI corresponding with each colored building in FIG. 13 is recognizable by a human.

Referring to FIG. 14, an enlarged portion of FIG. 13 (the portion within the rectangle 1302) illustrates a higher level of detail. In FIG. 14, dots represent positions of street view images (e.g., 1404), colored buildings correspond with buildings including POIs, and street crossings are shown with lines (e.g., 1402). More particularly, each colored building includes a POI recognized in three or more street view images (nb_image) where (a) recognition occurred within 20 meters of a crossing center and (b) the visual element_match for each of the nb_image was at least 80%. The colored lines represent associations between a POI and a crossing center. In one exemplary experiment, street view images were obtained for 76 crossings and, where possible (i.e., where POIs were visible), simplicity scores were determined for 42 of them. As will be described in further detail below, these simplicity scores can be used to generate travel directions having crossings with greater simplicity.

Referring to FIG. 15, a street crossings heat map illustrating simplicity scores for the above-mentioned part of Grenoble, France (FIG. 4) is provided. In one embodiment of the crossings heat map, magenta colored crossings possess higher simplicity scores, while cyan colored crossings possess lower simplicity scores. The crossings heat map includes four crossings respectively designated as “a,” “b,” “c,” and “d.” A normalized simplicity score was calculated for each one of the designated crossings, with the results of such calculations being shown in Table 2 which sets out calculated simplicity scores for four crossings in FIG. 15.

TABLE 2

| | Simplicity score | | Number of |
|---|---|---|---|
| Crossing | (normalized) | Rank | visible POI |
| a | 1.000 | 1 | 12 |
| b | 0.856 | 2 | 8 |
| c | 0.026 | 41 | 1 |
| d | 0.004 | 42 | 1 |

As illustrated by the crossings heat map of FIG. 15, each of the crossings corresponding respectively with a and b have relatively high simplicity scores, while the crossings corresponding respectively with c and d have relatively low simplicity scores. This indicates that visual elements associated with POIs (such as signage) at a and b are readily identified and recognized as a user traverses through these respective crossings, while visual elements associated with POIs at c and d are considerably more difficult to identify as a user traverses through those respective crossings.

e. Using simplicity score in Generating Travel Directions

Referring to FIG. 16, one embodiment describing how the above-described simplicity score can be used to generate travel directions is provided. At 1600, start and end points for a desired route is provided. Then, at 1602, each possible acceptable set of travel directions for the route is generated, noting that each “acceptable set of travel directions” has, as a minimum, an estimated travel length that is less than or equal to a selected maximum travel length. In 1604, in accordance with the above-described approach, a simplicity score is calculated for the crossings of each possible acceptable set of travel directions.

Referring to 1606 of FIG. 16, using the calculated simplicity scores (to calculate traversal times at respective crossings) along with road segments times (calculated, in one example, with data from a conventional database—see e.g., U.S. Pat. No. 6,092,076) estimated total travel time for each possible acceptable set of travel directions is calculated. Per 1608, an optimized set of travel directions is selected where the selected set includes both a maximized simplicity score and a total travel time that is less than or equal to a selected maximum acceptable travel time. The length selected for the maximum acceptable length (see 1602 above) or the maximum acceptable time (see 1608) can vary considerably, depending on the requirements of the user. One prior art study indicates that people are willing to increase the length of their walking route by up to 16% when provided with a more optimal route. In one embodiment, the value selected for maximum acceptable length or the maximum acceptable time could be based on input solicited from a user or even crowdsourcing. At 1610, the travel directions are stored in memory or buffered for eventual output.

Referring to FIG. 17, another embodiment describing how the above-described simplicity score can be used to generate travel directions is provided. As follows, the embodiment of FIG. 17 relates to a process for converting crossing simplicity into traversal time, managing it in a classical trip planning algorithm, and taking into account road and crossing segments. At 1700, start and end points for a desired route is provided.

Then, at 1702, each possible acceptable set of travel directions for the route is generated, noting that each “acceptable set of travel directions” has a estimated travel length that is less than or equal to a selected maximum travel length. In 1704, in accordance with the above-described approach, a simplicity score is calculated for the crossings of each possible acceptable set of travel directions.

Referring to 1706, traversal crossing time for each crossing can be obtained using the crossing travel time formula described above (in which normalized simplicity, among other variables, is employed). Also, at 1708, road segment time can be calculated, by reference to data in a conventional database, as indicated above. At 1710, the estimated travel time for each set of travel directions may be determined by adding corresponding road segment times and corresponding traversal crossing times. Travel time is then optimized, at 1712, by selecting the set of travel directions having the minimum estimated travel time. At 1714, the travel directions are stored in memory or buffered for eventual output.

Various advantages of the above-described embodiments should now be apparent to those skilled in the art.

First, generating a navigational plan with a landmark saliency score significantly increases the usability of the corresponding plan. That is, through use of such score in generating a plan, there is assurance that the landmarks referenced in corresponding navigational plans will be readily identifiable by a human user. In contrast to conventional landmark recognition approaches, where visual element recognition is typically used to identify landmarks under various ideal conditions, the above-described technique employs a machine-based implementation capable of mimicking human visual acuity. In essence, the technique accommodates for the actual difficulty a human might encounter in recognizing visual elements (such as text and logos) associated with landmarks.

Second, generating a navigational plan with a street crossing simplicity score also significantly increases the usability of the corresponding navigational plan. Use of the street crossing simplicity score in a corresponding navigational plan assures that landmarks around a given street crossing will be readily identifiable by a human user. In contrast to prior art approaches, where visual elements associated with landmarks typically provide direction indication, the embodiments use visual elements for the sake of identifying landmarks. Additionally, the street crossing simplicity score is particularly useful in determining the amount of time required to traverse a given street crossing, and use of the street crossing simplicity score in generating a navigational plan result in a plan optimizing both ease of street crossing traversal and total travel time.

Finally, the embodiments disclose a robust computer implemented circuit for determining landmark saliency and street crossing simplicity scores. By comparing a visual element match score with a suitably selected threshold, the capability to mimic human visual acuity is achieved. That is, by setting the threshold at an appropriate level, there is reasonably good assurance a human user will be able to recognize and identify associated landmarks referenced in a navigational plan. Additionally, by accounting for user recognition limit (“distance”) and cognitive cues (by way of assigning cognitive scores with the circuit), the capability of either the landmark score or the street crossing simplicity score to comply with a human user's capability to identify a corresponding landmark is further enhanced.

### 3. General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

It will be appreciated that various of the above-disclosed and other features and functions, or alternatives thereof, may be desirably combined into many other different systems or applications. For example, the methods above for computing a landmark saliency score or a street crossing simplicity score may be combined to operate together to generate travel directions. Also, various presently unforeseen or unanticipated alternatives, modifications, variations or improvements therein may be subsequently made by those skilled in the art and are also intended to be encompassed by the following claims.

What is claimed is:

1. A computer-implemented method for generating a navigational plan for a user in a geographical area that includes a plurality of streets upon which at least one point of interest is present, comprising:
generating one or more travel directions with a landmark saliency score for the at least one point of interest, the landmark saliency score representing a measure reflecting a degree to which a computer-based image recognition system can recognize a visual element in at least one electronic image, the visual element in the at least one electronic image serving to identify the at least one point of interest; and
outputting the navigational plan that includes the one or more travel directions;
wherein said generating obtains the landmark saliency score for the at least one point of interest from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.

2. The computer-implemented method of claim 1, wherein the visual element in the at least one electronic image is one of a text portion and a logo.

3. The computer-implemented method of claim 2, in which the one of the text portion and the logo comprises a logo and wherein said using the computer-based image recognition system includes recognizing the logo with a logo recognition engine.

4. The computer-implemented method of claim 2, in which the one of the text portion and the logo comprises text and said using the computer-based image recognition system includes recognizing the text with a text recognition engine.

5. The computer-implemented method of claim 1, wherein said determining that a selected relationship exists includes using image matching to determine whether the selected relationship exists between the visual element in the at least one electronic image and the previously stored visual element.

6. The computer-implemented method of claim 5, in which the visual element includes a text portion, wherein said image matching includes using fuzzy matching to determine that the selected relationship exists between the text portion in the at least one electronic image and a text portion in the previously stored visual element.

7. The computer-implemented method of claim 1, further comprising:
determining, responsive to said comparing, that an image match exists between the visual element in the at least one electronic image and the previously stored visual element;
responsive to said determining that the image match exists, assigning an image match score; and
wherein said determining that a selected relationship exists includes determining that the image match score is equal to or greater than a selected image match threshold.

8. The computer-implemented method of claim 7, wherein said obtaining of the landmark saliency score further comprises assigning a cognitive score to the at least one point of interest, the cognitive score reflecting a degree to which the at least one point of interest would be identified by a human in accordance with common knowledge of points of interest.

9. The computer-implemented method of claim 8, further comprising storing the at least one point of interest in a database.

10. The computer-implemented method of claim 8, wherein the landmark saliency score varies as a function of the image match score, the cognitive score and a distance calculated from at least one of the plurality of electronic images, and wherein the distance calculated from at least one of the plurality of electronic images corresponds with a maximized user recognition limit.

11. The computer-implemented method of claim 1 in which the geographical area includes a plurality of neighborhoods of varying respective sizes, further comprising normalizing the landmark saliency score to accommodate for differences in neighborhood size.

12. The computer-implemented method of claim 1, further comprising selecting the landmark saliency score from a list of ranked landmark saliency scores.

13. A computer-implemented method for generating a navigational plan for a user in a geographical area that includes a plurality of streets with at least two of the streets forming a street crossing, comprising:
generating one or more travel directions with a street crossing simplicity score, the street crossing simplicity score representing a measure reflecting a degree to which a computer-based image recognition system can recognize a visual element in at least one electronic image, the visual element in the at least one electronic image serving to identify at least one point of interest within a selected distance of a location associated with the street crossing; and
outputting the navigational plan that includes the one or more travel directions;
wherein said generating obtains the street crossing simplicity score from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.

14. The computer-implemented method of claim 13, wherein said generating includes (a) generating a plurality of navigational plans, and (b) selecting a navigational plan, from the plurality of navigational plans, that optimizes both ease of street crossing traversal and total travel time.

15. The computer-implemented method of claim 14 in which a simplicity score is calculated for one or more street crossings in each one of the plurality of navigational plans, and an estimated total travel time is calculated for each one of the plurality of navigational plans, wherein said selecting a navigational plan includes selecting a navigational plan in which both the simplicity score is maximized and the total travel time is less than or equal to a selected maximum acceptable travel time.

16. The computer-implemented method of claim 14 in which, for each one of the plurality of navigational plans, a traversal time for each pertinent street crossing and each pertinent road segment time are determined, and in which, for each one of the plurality of navigational plans, an estimated travel time is equal to the sum of all pertinent street crossing traversal times and all pertinent road segment times, wherein said selecting a navigational plan includes selecting the navigational plan with a minimum estimated travel time.

17. The computer-implemented method of claim 13, wherein the visual element in the at least one electronic image is one of a text portion and a logo.

18. The computer-implemented method of claim 17, in which the one of the text portion and the logo is a logo and wherein said using the computer-based image recognition system comprises recognizing the logo with a logo recognition engine.

19. The computer-implemented method of claim 17, in which the one of the text portion and the logo comprises text and said using the computer-based image recognition system comprises recognizing the text with a text recognition engine.

20. The computer-implemented method of claim 13, wherein said determining that a selected relationship exists comprises using image matching to determine whether the selected relationship exists between the visual element in the at least one electronic image and the previously stored visual element.

21. The computer-implemented method of claim 20 in which the visual element in the at least one electronic image includes a text portion, wherein said image matching includes using fuzzy matching to determine whether the selected relationship exists between the text portion in the at least one electronic image and a text portion in the previously stored visual element.

22. The computer-implemented method of claim 13, further comprising:
determining, responsive to said comparing, that an image match exists between the visual element in the at least one electronic image and the previously stored visual element;
responsive to determining that an image match exists, assigning an image match score; and
wherein said selected relationship exists when the image match score is equal to or greater than a selected image match threshold.

23. The computer-implemented method of claim 22, wherein said obtaining of the street crossing simplicity score further comprises assigning a cognitive score to the at least one point of interest, the cognitive score reflecting a degree to which the at least one point of interest would be identified by a human in accordance with common knowledge of points of interest in general.

24. The computer-implemented method of claim 23, wherein:
said obtaining of the street crossing simplicity score further comprises calculating a visibility score for each identifiable point of interest around at least one street crossing;
the visibility score varies as a function of the image match score, the cognitive score and a distance parameter; and
for each one of the plurality of electronic images, the distance parameter is defined as a distance between a geographic location associated with the electronic image and a corresponding street crossing location.

25. The computer-implemented method of claim 13 in which a plurality of visibility scores are calculated for one street crossing, wherein the street crossing simplicity score for the one street crossing is obtained by adding the plurality of visibility scores together.

26. An apparatus for generating information relating to at least one point of interest from a plurality of electronic images, the information relating to the at least one point of interest being usable to generate travel directions for a navigational plan, comprising:
an image recognition platform for performing image recognition on at least one of the plurality of electronic images to identify at least one of a text portion and a logo;
an image matching module for comparing the at least one of the text portion and the logo with each text portion or logo in a points of interest database to obtain an image recognition score for the at least one of the text portion and the logo; said image matching module determining whether a selected relationship exists between the at least one of the text portion and the logo and at least one point of interest designated in the points of interest database;
a cognitive scoring module, said cognitive scoring module assigning a cognitive score to a point of interest corresponding with the at least one of the text portion and the logo when the selected relationship exists, the cognitive score reflecting a degree to which the point of interest corresponding with the at least one of the text portion and the logo can be identified by a human in accordance with common knowledge of points of interest; and
an enhanced points of interest database, the point of interest corresponding with the at least one of the text portion and the logo being stored in said enhanced points of interest database;
wherein the information relating to the at least point of interest includes one of a landmark saliency score and a street crossing simplicity score, each of one of the landmark saliency score and street crossing simplicity score representing a measure reflecting a degree to which said image recognition module recognizes the at least one of the text portion and the logo in one of the plurality of electronic images.

27. The apparatus of claim 26, wherein the image recognition score for the at least one of the text portion and the logo is greater than or equal to a selected threshold.

28. The apparatus of claim 26 in which the at least one of a text portion and a logo comprises a text portion, wherein said image matching module uses fuzzy matching to determine whether the selected relationship exists between the text portion and at least one point of interest designated in the points of interest database.

29. The apparatus of claim 26, wherein the information relating to the at least point of interest includes one of a landmark saliency score and a street crossing simplicity score, each of one of the landmark saliency score and street crossing simplicity score representing a measure reflecting a degree to which said image recognition module recognizes the at least one of the text portion and the logo in one of the plurality of electronic images.

30. A computer-implemented method for generating a navigational plan for a user in a geographical area that includes a plurality of streets (a) upon which at least one point of interest is present and (b) with at least two of the streets forming a street crossing, comprising:
generating one or more travel directions using one or more of (x) a landmark saliency score for the at least one point of interest, the landmark saliency score representing a measure reflecting a degree to which a computer-based image recognition system can recognize a visual element in at least one electronic image, and (y) a street crossing simplicity score, the street crossing simplicity score representing a measure reflecting a degree to which a computer-based image recognition system can recognize a visual element in at least one electronic image, the visual element in the at least one electronic image serving to identify, respectively, (v) the at least one point of interest, or (w) at least one point of interest within a selected distance of a location associated with the street crossing; and
outputting the navigational plan that includes the one or more travel directions;
wherein said generating obtains one or more of the landmark saliency score for the at least one point of interest and the street crossing simplicity score from a plurality of electronic images captured along at least one of the plurality of streets in the geographical area, the plurality of electronic images including the at least one electronic image, wherein said obtaining includes using the computer-based image recognition system to (i) recognize the visual element in the at least one electronic image, (ii) compare the visual element in the at least one electronic image with a previously stored visual element where the previously stored visual element is associated with a point of interest, and (iii) determine that a selected relationship exists between the visual element in the at least one electronic image and the previously stored visual element.
